(19) United States
(12) Patent Application Publication
(10) Pub. No.: US 2022/0343171 A1
(43) Pub. Date: Oct. 27, 2022

(54) METHODS AND APPARATUS TO CALIBRATE ERROR ALIGNED UNCERTAINTY FOR REGRESSION AND CONTINUOUS STRUCTURED PREDICTION TASKS

(71) Applicants: Neslihan Kose Cihangir, Munich (DE); Omesh Tickoo, Portland, OR (US); Ranganath Krishnan, Hillsboro, OR (US); Ignacio J. Alvarez, Portland, OR (US); Michael Paulitsch, Ottobrunn (DE); Akash Dhamasia, Munich (DE)

(72) Inventors: Neslihan Kose Cihangir, Munich (DE); Omesh Tickoo, Portland, OR (US); Ranganath Krishnan, Hillsboro, OR (US); Ignacio J. Alvarez, Portland, OR (US); Michael Paulitsch, Ottobrunn (DE); Akash Dhamasia, Munich (DE)

(21) Appl. No.: 17/855,774

(22) Filed: Jun. 30, 2022

Related U.S. Application Data
(60) Provisional application No. 63/313,688, filed on Feb. 24, 2022.

(51) Int. Cl. G06N 3/08

(52) U.S. Cl. CPC G06N 3/08

(57) ABSTRACT

Methods, apparatus, systems, and articles of manufacture are disclosed that calibrate error aligned uncertainty for regression and continuous structured prediction tasks/optimizations. An example apparatus includes a prediction model, at least one memory, instructions, and processor circuitry to at least one of execute or instantiate the instructions to calculate a count of samples corresponding to an accuracy-certainty classification category, calculate a trainable uncertainty calibration loss value based on the calculated count, calculate a final differentiable loss value based on the trainable uncertainty calibration loss value, and calibrate the prediction model with the final differentiable loss value.

### FIELD OF THE DISCLOSURE

This disclosure relates generally to deep learning and, more particularly, to calibrating uncertainty for regression and continuous structured model prediction tasks.

### BACKGROUND

In recent years, the field of deep learning in artificial intelligence has provided significant valuable in the extraction of important information out of large data sets. As data continues to be generated at ever increasing rates, the ability to make intelligent decisions based on large sets of data is vital to increase the efficiency of data analysis. Deep learning applications are useful across many industries that have a demand for large amounts of data, such as autonomous driving. The predictions of data-learned models may be calibrated for uncertainty. A well-calibrated model is expected to show low uncertainty when predictions are accurate and higher uncertainty when predictions are less accurate.

### BRIEF DESCRIPTION OF THE DRAWINGS

FIG. 1 is an illustration of an example system to calibrate uncertainty in a prediction model.

FIG. 2 is a flowchart representative of example machine readable instructions and/or example operations that may be executed and/or instantiated by processor circuitry to calibrate error aligned uncertainty for regression and continuous structured prediction tasks/optimizations.

FIG. 3 is a block diagram of an example processing platform including processor circuitry structured to execute the example machine readable instructions of FIG. 2 to calibrate error aligned uncertainty for regression and continuous structured prediction tasks/optimizations.

FIG. 4 is a block diagram of an example implementation of the processor circuitry of FIG. 3.

FIG. 5 is a block diagram of another example implementation of the processor circuitry of FIG. 3.

FIG. 6 is a block diagram of an example software distribution platform (e.g., one or more servers) to distribute software (e.g., software corresponding to the example machine readable instructions of FIG. 2) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

FIG. 7 illustrates the results for the joint quality assessment of uncertainty and robustness using R-AUC, F1-AUC, F1 @95% metrics.

FIG. 8 illustrates error retention plot (left) and F1-weightedADE retention plot (right) for both BC and DIM baselines with/without the calibration loss.

FIG. 9 illustrates an evaluation of Pearson's correlation coefficient where X and Y had observed improvement in correlation of error and uncertainty incorporating L_{EaUC} loss to BC and DIM models, respectively.

FIG. 10 illustrates the results of uncertainty predictions as a result of assigning higher weights to the LC classification.

FIG. 11 illustrates an example Bayesian Neural Network (BNN) trained with a secondary EaUC loss yields lower predictive negative log likelihood and lower RMSE on multiple UCI datasets.

FIG. 12 depicts a high-level overview of an autonomous driving pipeline, based on the teachings of this disclosure.

The figures are not to scale. Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events. As used herein, “processor circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmed with instructions to perform specific operations and including one or more semiconductor-based logic devices (e.g., electrical hardware implemented by one or more transistors). Examples of processor circuitry include programmed microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of the processing circuitry is/are best suited to execute the computing task(s).

### DETAILED DESCRIPTION

Artificial intelligence (AI), including machine learning (ML), deep learning (DL), and/or other artificial machine-driven logic, enables machines (e.g., computers, logic circuits, etc.) to use a model to process input data to generate an output based on patterns and/or associations previously learned by the model via a training process. For instance, the model may be trained with data to recognize patterns and/or associations and follow such patterns and/or associations when processing input data such that other input(s) result in output(s) consistent with the recognized patterns and/or associations.

Many different types of machine learning models and/or machine learning architectures exist. In some examples disclosed herein, a Neural Network (NN) model is used. Using a Neural Network (NN) model enables the interpretation of data wherein patterns can be recognized. In general, machine learning models/architectures that are suitable to use in the example approaches disclosed herein will be Convolutional Neural Network (CNN) and/or Deep Neural Network (DNN), wherein interconnections are not visible outside of the model. However, other types of machine learning models could additionally or alternatively be used such as Recurrent Neural Network (RNN), Support Vector Machine (SVM), Gated Recurrent Unit (GRU), Long Short Term Memory (LSTM), etc.

In general, implementing a ML/AI system involves two phases, a learning/training phase and an inference phase. In the learning/training phase, a training algorithm is used to train a model to operate in accordance with patterns and/or associations based on, for example, training data. In general, the model includes internal parameters that guide how input data is transformed into output data, such as through a series of nodes and connections within the model to transform input data into output data. Additionally, hyperparameters are used as part of the training process to control how the learning is performed (e.g., a learning rate, a number of layers to be used in the machine learning model, etc.). Hyperparameters are defined to be training parameters that are determined prior to initiating the training process.

Different types of training may be performed based on the type of ML/AI model and/or the expected output. For example, supervised training uses inputs and corresponding expected (e.g., labeled) outputs to select parameters (e.g., by iterating over combinations of select parameters) for the ML/AI model that reduce model error. As used herein, labelling refers to an expected output of the machine learning model (e.g., a classification, an expected output value, etc.) Alternatively, unsupervised training (e.g., used in deep learning, a subset of machine learning, etc.) involves inferring patterns from inputs to select parameters for the ML/AI model (e.g., without the benefit of expected (e.g., labeled) outputs).

In examples disclosed herein, ML/AI models are trained using known vehicle trajectories (e.g., ground truth trajectories). Training is performed using hyperparameters that control how the learning is performed (e.g., a learning rate, a number of layers to be used in the machine learning model, etc.).

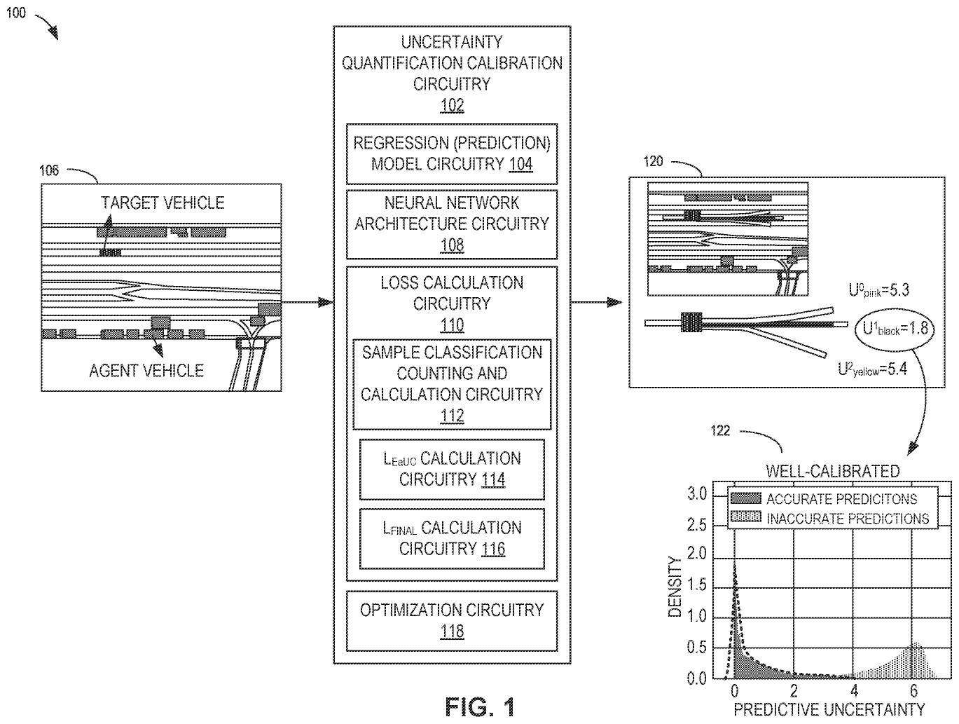

Conventional deep learning models often make unreliable predictions, and a measure of uncertainty is not provided in regression tasks with such models. Uncertainty estimation is crucial in particular for safety-critical tasks such as in Autonomous Driving for informed decision making. For a reliable model, the model uncertainty should correlate with its prediction error. Uncertainty calibration is applied to improve the quality of uncertainty estimates, hence more informed decision making is possible on the model prediction during inference. A well-calibrated model indicates low uncertainty about its prediction when the model is accurate and indicates high uncertainty when it is likely to be inaccurate (see FIG. 1). Due to the unavailability of ground truth for uncertainty estimates, uncertainty calibration is a challenging problem.

The existing approaches for uncertainty calibration have been applied for classification tasks or post-hoc finetuning. For example, current differentiable accuracy versus uncertainty calibration loss functions are limited in application to classification tasks. Additionally, current post-hoc uncertainty calibration methods do not provide well calibrated uncertainties under distributional shifts in real world applications. Continuous structured prediction introduces greater complexities compared to regression problems because it is based on time series analysis. Various approaches exist to estimate uncertainty in neural network predictions including Bayesian and non-Bayesian methods.

Examples are disclosed herein to calibrate error aligned uncertainty for regression and continuous structured prediction tasks/optimizations. The example optimizations disclosed herein are orthogonal and can be applied in conjunction with methods described above to further improve uncertainty estimates.

Error aligned uncertainty calibrations can be applied to many different usage cases across industries, such as in autonomous driving, robotics, industrial manufacturing, etc. Uncertainty estimation is commonly utilized with safety critical tasks that involve image and other sensor inputs. For ease of explanation, the examples described below will focus on an autonomous driving application but can be applied to any other application that involves uncertainty estimations.

FIG. 1 is an illustration of an example system 100 to calibrate error aligned uncertainty in a prediction model, including a block diagram of example uncertainty quantification calibration circuitry 102. The uncertainty quantification calibration circuitry 102 of FIG. 1 may be instantiated (e.g., creating an instance of, bring into being for any length of time, materialize, implement, etc.) by processor circuitry such as a central processing unit executing instructions. Additionally or alternatively, the uncertainty quantification calibration circuitry 102 of FIG. 1 may be instantiated (e.g., creating an instance of, being into being for any length of time, materialize, implement, etc.) by an ASIC or an FPGA structured to perform operations according to the instructions. It should be understood that some or all of the circuitry of FIG. 1 may, thus, be instantiated at the same or different times. Some or all of the circuitry may be instantiated, for example, in one or more threads executing concurrently on hardware and/or in series on hardware. Moreover, in some examples, some or all of the circuitry of FIG. 1 may be implemented by microprocessor circuitry executing instructions to implement one or more virtual machines and/or containers.

In some examples, the example uncertainty quantification calibration circuitry 102 receives (e.g., obtains) input 106 for a regression (e.g., prediction) model circuitry 104. The regression model circuitry 104 may include processor circuitry and memory that instantiates a regression model. The input 106 for the example regression model circuitry 104 is a single scene (e.g., a series of images) context x consisting of static input features (e.g., map of the environment that can be augmented with extra information such as crosswalk occupancy, lane availability, direction, and speed limit) and time-dependent input features (e.g., occupancy, velocity, acceleration and yaw for vehicles and pedestrians in the scene). In some examples, the output 120 of the regression model circuitry 104 is D top trajectory predictions (y^{(d)}|d ∈ 1, . . . , D) for the future movements of the target vehicle together with their corresponding confidence scores (c^{(d)}|d ∈ 1, . . . , D) or uncertainty scores (u^{(d)}|d ∈ 1, . . . , D, as shown in FIG. 1) as well as a single per-prediction request uncertainty score U. As used herein, c (confidence) and u (uncertainty) are interchangeable and either can be utilized with the knowledge that a higher c (confidence) indicates a lower u (uncertainty).

In some examples, a training set to train the regression model circuitry 104 for vehicle motion prediction is denoted as Dₜᵣₐᵢₙ=(xᵢ,yᵢ)^{N}ᵢ₌₁. In some examples, y denotes the ground truth trajectories paired with high-dimensional features x of the corresponding scenes. Each example y=(s₁, . . . , s_{T}) corresponds to the trajectory of a given vehicle observed by the automated vehicle perception stack, and each state st corresponds to the dₓ- and d_{y}-displacement of the vehicle at timestep t, such that y ∈ R^{T×2}. In some examples, the training set (e.g., inputs like input 106) includes images (e.g., a series of images that make up a scene or multiple scenes) and/or data associated with images that provide information on vehicle locations and trajectories over time.

In some examples, a given scene is M seconds long and divided into K seconds of context features and L seconds of ground truth targets for prediction separated by the time T=0. The goal is to predict the movement trajectory of vehicles at time T ∈ (0, L] based on the information available for time T ∈ [−K, 0].

In some examples, the uncertainty quantification calibration circuitry 102 includes a neural network architecture circuitry 108. The neural network architecture circuitry 108 instantiates one or more of any type of artificial neural networks (ANN) (e.g., a deep neural network (DNN)) that includes nodes, layers, weights, etc. to be utilized to train the regression model. The neural network architecture circuitry 108 may include processor circuitry and memory that instantiates a neural network.

Motion prediction is a multi-modal task. In some examples, incorporation of uncertainty into motion prediction includes introducing two types of uncertainty quantification metrics:

Per-trajectory confidence-aware metrics: For a given input x, an example stochastic model accompanies its D top trajectory predictions with scalar per-trajectory confidence scores (c⁽ⁱ⁾|i ∈ 1, . . . , D) based on e.g., log-likelihood.

Per-prediction request confidence-aware metrics: U is computed by aggregating the D top per-trajectory confidence scores to a single uncertainty score (e.g., U=−(Σ^{D}ᵢ₌₁c⁽ⁱ⁾)/D).

In some examples, an automated vehicle associates a high per-prediction request uncertainty in the existence of unfamiliar or high-risk scene context. However, since uncertainties do not have ground truth, assessing the quality of these uncertainty measures is challenging.

In some examples, robustness to distributional shift is assessed via metrics of predictive performance such as Average Displacement Error (ADE) or Mean Square Error (MSE) in case of continuous structured prediction and regression tasks, respectively. In some examples, ADE is a standard performance metric for time-series data and measures the quality of a prediction y with respect to the ground truth y* as:

$$Average displacement error ( A D E ) \\ calculation function . \qquad Equation 1$$

$$A D E ( y ) := \frac{1}{T} {{\sum }^{T}}_{t = 1} {‖ {s}_{t} - {s}_{t}^{*} ‖}_{2} .$$

where y=(s₁, . . . , s_{T}).

In some examples, the analysis is done with two types of evaluation datasets, which are the in-distribution and shifted datasets. Models which have a smaller degradation in performance on the shifted data are considered more robust.

In some examples, there are situations where a model performs well on shifted data and poorly on in-distribution data. Thus, in some examples, joint assessment of the quality of uncertainty estimates and robustness to distributional shift is utilized. Joint analysis enables an understanding of whether measures of uncertainty correlate well with the presence of an incorrect prediction or a high degree of error.

In some examples, error and F1 retention curves are utilized for joint assessment. The area under error retention curve (R-AUC) can be decreased either by improving the model such that it has lower overall error, or by providing better estimates of uncertainty such that predictions with more errors are rejected earlier. In some examples, for F1-retention curves, a higher area under curve (F1-AUC) indicates better calibration performance. In some examples, the dataset used contains both an ‘in-distribution’ and a distributionally shifted subset.

In the illustrated example of FIG. 1, a loss calculation circuitry 110 calculates a total certainty loss for the regression model circuitry 104 prediction that includes a loss attributed to an error aligned uncertainty calibration (EaUC). The example EaUC is included for regression and continuous structured prediction tasks to increase the quality of uncertainty estimates using Bayesian decision theory. Increased quality of uncertainty measurements correlates with the corresponding error measure. In some examples, incorporating a differentiable L_{EaUC} loss to a total certainty loss calculation increases calibration precision and improves the robustness of the regression model circuitry 104.

In some examples, for regression and continuous structured prediction tasks, robustness is measured in terms of MSE and ADE, respectively, instead of accuracy score. Lower MSE and ADE indicate more accurate results.

In some examples, two metrics are used to classify predictions of samples (e.g., sample sequences of images used from a scene): certainty and accuracy. As used herein, the following annotations are used to show the count of each of the four possible classifications of predictions: the number of accurate and certain samples (nLC), the number of inaccurate and certain samples (nHC), the number of accurate and uncertain samples (nLU) and the number of inaccurate and uncertain samples (nHU). This classification grid is illustrated in Table 1 below.

TABLE 1
Prediction classifications.

Certainty

| | | Certain | Uncertain |
|---|---|---|---|
| Accuracy | Low | LC | LU |
| (ADE) | High | HC | HU |

In some examples, the regression model is more certain about predictions when it is accurate and less certain about inaccurate predictions. In some examples, the goal is to have a greater number of certain samples when the predictions are accurate (LC) vs. inaccurate (HC) and have a greater number of uncertain samples when the predictions are inaccurate (HU) vs. accurate (LU). Thus, in some examples, a reliable and well-calibrated model provides a higher EaU measure (EAU ∈ [0, 1]). An example Equation 2 illustrates how the EaU measure is calculated (e.g., an EaU indicator function).

$$EaU calculation function . \qquad Equation 2$$

$$EaU = \frac{{n}_{LC} + {n}_{UH}}{{n}_{LC} + {n}_{LU} + {n}_{HC} + {n}_{HU}} .$$

An example chart of predictive uncertainty 122 for a well-calibrated model is shown in FIG. 1. The distribution shows that the density of samples clusters at largely accurate predictions (e.g., low predictive uncertainty) and largely inaccurate predictions (e.g., high predictive uncertainty).

An example Equation 3 illustrates how to count and/or calculate the number of samples that fall into each of four accuracy-certainty classification categories. In some examples, the example set of equations in Equation 3 may change based on the nature of the certainty parameters provided (e.g., “less than” may switch to “greater than” if uncertainty parameters are provided).

$$The calculation function to count \\ of each of four prediction accuracy - certainty \\ classification categories . \qquad Equation ( s ) 3$$

$${n}_{L U} := {\sum }_{i} 1 ( {ade}_{i} \leq {ade}_{th} and {c}_{i} \leq {c}_{th} )$$

$${n}_{H C} := {\sum }_{i} 1 ( {ade}_{i} > {ade}_{th} and {c}_{i} > {c}_{th} )$$

$${n}_{L C} := {\sum }_{i} 1 ( {ade}_{i} \leq {ade}_{th} and {c}_{i} > {c}_{th} )$$

$${n}_{H U} := {\sum }_{i} 1 ( {ade}_{i} > {ade}_{th} and {c}_{i} \leq {c}_{th} ) .$$

In some examples, average displacement error (adeᵢ) as the robustness measure to classify the sample as accurate or inaccurate comparing it with a task-dependent threshold (adeₜₕ). In some examples, the adeₜₕ is determined upon evaluation of a pre-training result. In some examples, the samples are classified as certain or uncertain according to the confidence score c of each sample. The cᵢ is based on “log likelihood” in the continuous structured prediction. Similarly, in some examples, the log likelihood of each sample, which is our certainty measure, is compared with a task-dependent threshold ctₕ.

As the equations in Equation 3 are not differentiable, the loss calculation circuitry 110 includes a trainable uncertainty calibration loss (L_{EaUC}) calculation circuitry 114 and a sample classification counting and calculation circuitry 112 to provide differentiable approximations (e.g., proxy functions) for the indicator functions illustrated in Equations 2 and 3. The L_{EaUC} serves as the utility-dependent penalty term within the loss-calibrated approximate inference framework for regression and continuous structured prediction tasks. In some examples, the L_{EaUC} calculation circuitry 114 calculates the L_{EaUC} using the calculation function shown in Equation 4. In some examples, the sample classification counting and calculation circuitry 112 calculates the counts of samples of each classification type using the calculation functions shown in Equation 5.

$${L}_{EaUC} calculation function . \qquad Equation 4$$

$${L}_{EaUC} = - log ( \frac{{n}_{L C} + {n}_{H U}}{{n}_{L C} + {n}_{L U} + {n}_{H C} + {n}_{H U}} ) .$$

where:

$$The calculation functions to count differential \\ approximations of each of four prediction \\ accuracy - certainty classification categories . \qquad Equation ( s ) 5$$

$${n}_{L U} = {\sum }_{i ∈ \{ x \cdot {ade}_{i} \leq {ade}_{t h} and y \cdot {c}_{i} \leq {c}_{t h} \}} ( 1 - tan h ( x \cdot {ade}_{i} ) ) ( 1 - y \cdot {c}_{i} )$$

$${n}_{LC} = {\sum }_{i ∈ \{ x \cdot {ade}_{i} \leq {ade}_{t h} and y \cdot {c}_{i} > {c}_{t h} \}} ( 1 - tan h ( x \cdot {ade}_{i} ) ) ( y \cdot {c}_{i} )$$

$${n}_{HC} = {\sum }_{i ∈ \{ x \cdot {ade}_{i} > {ade}_{t h} and y \cdot {c}_{i} > {c}_{t h} \}} tan h ( x \cdot {ade}_{i} ) ( y \cdot {c}_{i} )$$

$${n}_{HU} = {\sum }_{i ∈ \{ x \cdot {ade}_{i} > {ade}_{t h} and y \cdot {c}_{i} \leq {c}_{t h} \}} tan h ( x \cdot {ade}_{i} ) ( 1 - y \cdot {c}_{i} ) .$$

In some examples, the sample classification counting and calculation circuitry 112 uses a hyperbolic tangent function as a bounding function to scale the error and/or uncertainty measures to the range [0, 1]. The example approximate functions show that the bounded error tanh(ade)→0 when the predictions are accurate and tanh(ade)→1 when inaccurate. To scale the robustness and uncertainty measures to the appropriate range for the bounding function or to be used directly, the sample classification counting and calculation circuitry 112 applies a post-processing on the robustness measure adeᵢ and uncertainty measure cᵢ with x and y, shown in in Equation 4, respectively. In some examples, the post-processing steps are adapted according to each performed task based on the results of initial training epochs. In some examples, the L_{EaUC} is a secondary loss and is added to the standard negative log likelihood loss (L_{NLL}).

In the illustrated example of FIG. 1, the loss calculation circuitry 110 includes a final loss (L_{FINAL}) calculation circuitry 116 that calculates the final loss (L_{FINAL}) from the combined results of the L_{NLL} and the L_{EaUC}. Equation 6 illustrates the final loss function used by the L_{FINAL} calculation circuitry 116 for a continuous structured prediction task:

L_{Final}=L_{NLL}+(β×L_{EaUC})
Equation 6. L_{Final} calculation function.

In some examples, to have a significant impact from the secondary loss, the L_{EaUC} value may be weighted with a β hyperparameter in the final loss calculation, which is determined by comparing/analyzing the primary loss value (L_{NLL}) to the initially calculated L_{EaUC} value. In some examples, under ideal conditions, the proxy functions defined in Equations 4 and 5 are equivalent to the indicator functions defined in Equations 2 and 3.

In safety-critical scenarios, it is important to be certain when predictions are accurate. In some examples, the sample classification counting and calculation circuitry 112 and the L_{EaUC} calculation circuitry 114 provide higher weights to the class of LC samples while calculating Equations 4 and 5. Equation 7 illustrates how high weights are assigned by the L_{EaUC} calculation circuitry 114 to these samples in our loss, where s>1.

$${L}_{EaUC} calculation function \\ with additional weights for LC samples . \qquad Equation 7$$

$${L}_{EaUC} = - log ( \frac{( s \cdot {n}_{LC} ) + {n}_{H U}}{( s \cdot {n}_{LC} ) + {n}_{LU} + {n}_{HC} + {n}_{H U}} ) .$$

In some examples, the uncertainty quantification calibration circuitry 102 includes an optimization circuitry 118 to calibrate the regression (prediction) model circuitry 104 using the L_{FINAL} calculation function results to calibrate the regression model 104 (e.g., during training of the model) for an increased robustness of predictions.

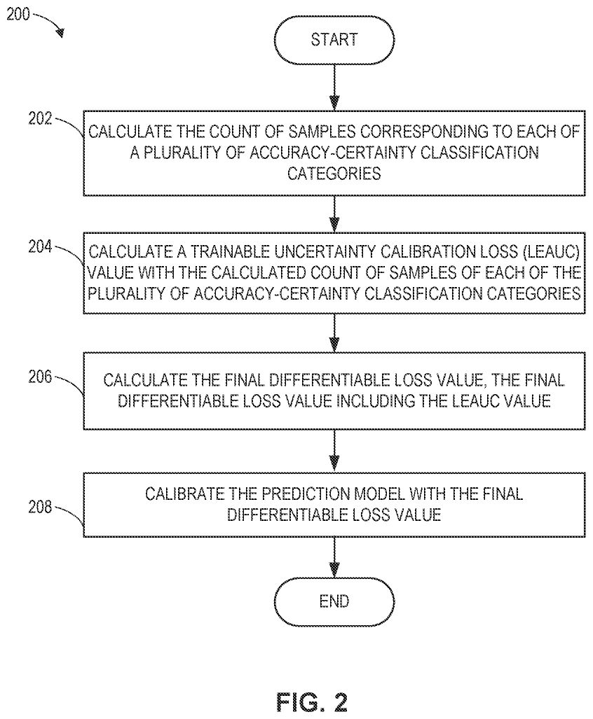

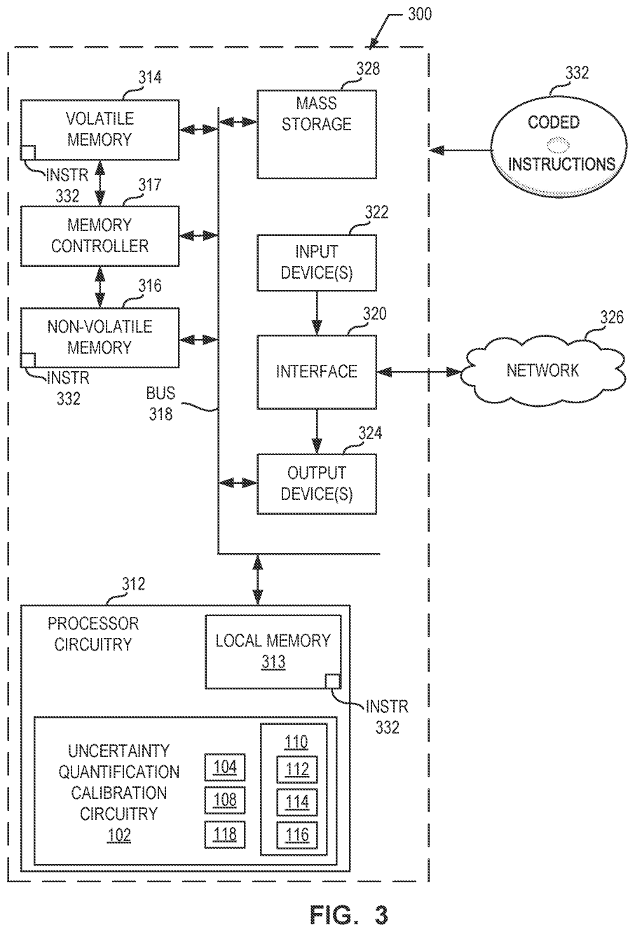

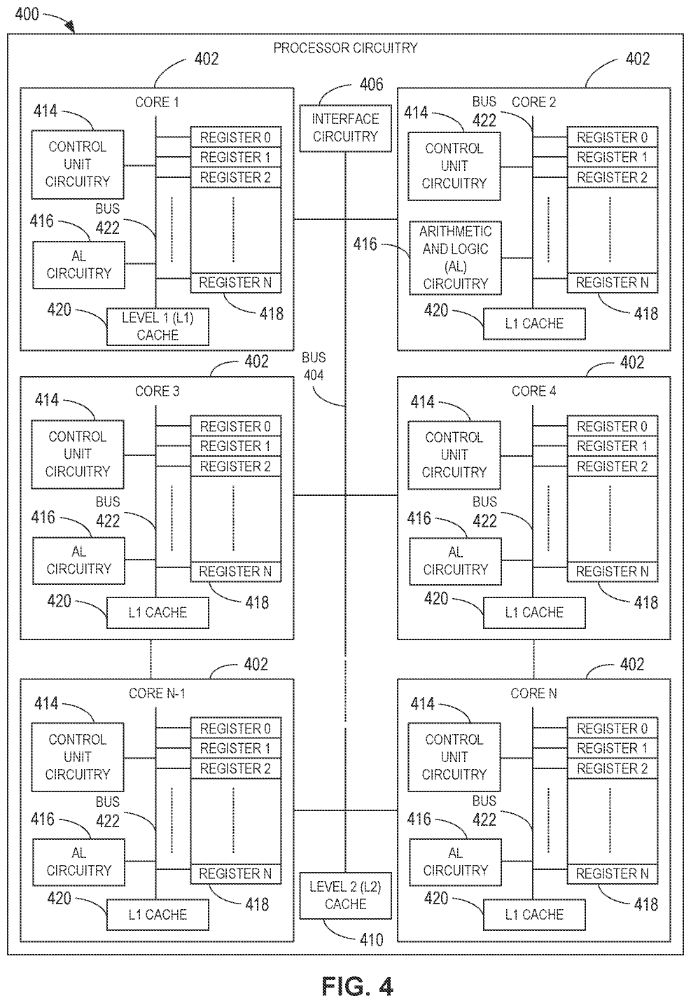

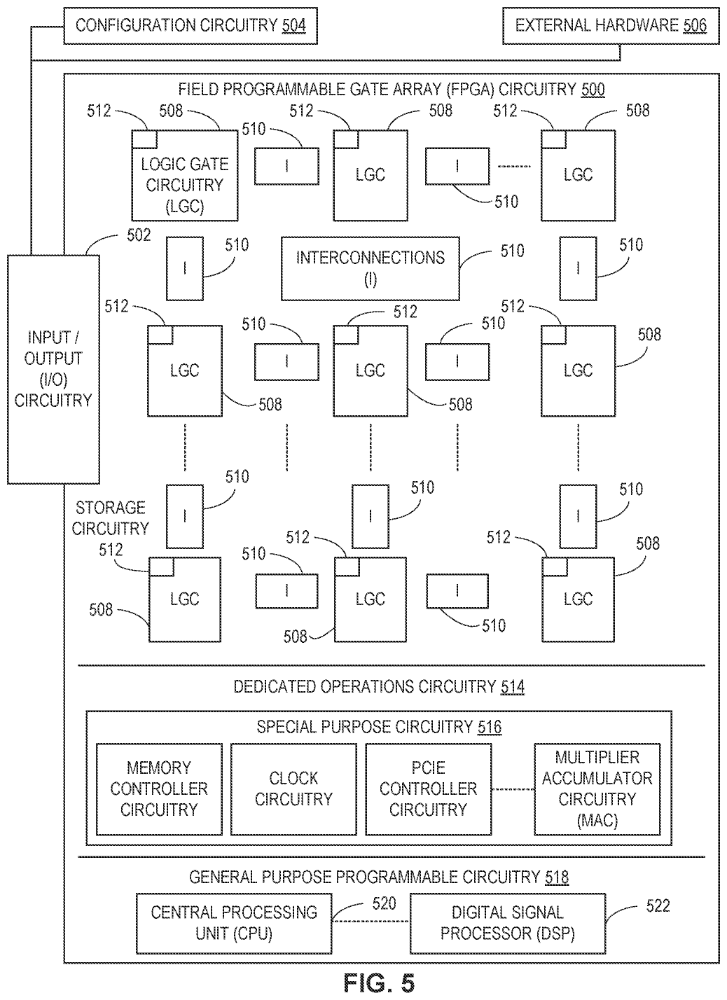

In some examples, the uncertainty quantification calibration circuity 102 includes means for instantiating a regression model. For example, the means for instantiating a regression model may be implemented by regression (prediction) model circuitry 104. In some examples, the regression (prediction) model circuitry 104 may be instantiated by processor circuitry such as the example processor circuitry 312 of FIG. 3. For instance, the regression (prediction) model circuitry 104 may be instantiated by the example microprocessor 400 of FIG. 4 executing machine executable instructions such as those implemented by at least block 202 of FIG. 2. In some examples, the regression (prediction) model circuitry 104 may be instantiated by hardware logic circuitry, which may be implemented by an ASIC, XPU, or the FPGA circuitry 500 of FIG. 5 structured to perform operations corresponding to the machine readable instructions. Additionally or alternatively, the regression (prediction) model circuitry 104 may be instantiated by any other combination of hardware, software, and/or firmware. For example, the regression (prediction) model circuitry 104 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the uncertainty quantification calibration circuity 102 includes means for instantiating instantiates one or more of any type of artificial neural networks (ANN) (e.g., a deep neural network (DNN)) that includes nodes, layers, weights, etc. to be utilized to train the regression model. For example, the means for instantiating instantiates one or more of any type of artificial neural networks (ANN) (e.g., a deep neural network (DNN)) that includes nodes, layers, weights, etc. to be utilized to train the regression model may be implemented by neural network architecture circuitry 108. In some examples, the neural network architecture circuitry 108 may be instantiated by processor circuitry such as the example processor circuitry 312 of FIG. 3. For instance, the neural network architecture circuitry 108 may be instantiated by the example microprocessor 400 of FIG. 4 executing machine executable instructions such as those implemented by at least block 202 of FIG. 2. In some examples, the neural network architecture circuitry 108 may be instantiated by hardware logic circuitry, which may be implemented by an ASIC, XPU, or the FPGA circuitry 500 of FIG. 5 structured to perform operations corresponding to the machine readable instructions. Additionally or alternatively, the neural network architecture circuitry 108 may be instantiated by any other combination of hardware, software, and/or firmware. For example, the neural network architecture circuitry 108 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the uncertainty quantification calibration circuity 102 includes means for calculating a total certainty loss for the regression model circuitry's 104 prediction that includes a loss attributed to an error aligned uncertainty calibration (EaUC). For example, the means for calculating a total certainty loss for the regression model circuitry's 104 prediction that includes a loss attributed to an error aligned uncertainty calibration (EaUC) may be implemented by loss calculation circuitry 110. In some examples, the loss calculation circuitry 110 may be instantiated by processor circuitry such as the example processor circuitry 312 of FIG. 3. For instance, the loss calculating circuitry 110 may be instantiated by the example microprocessor 400 of FIG. 4 executing machine executable instructions such as those implemented by at least blocks 202-208 of FIG. 2. In some examples, the loss calculating circuitry 110 may be instantiated by hardware logic circuitry, which may be implemented by an ASIC, XPU, or the FPGA circuitry 500 of FIG. 5 structured to perform operations corresponding to the machine readable instructions. Additionally or alternatively, the loss calculation circuitry 110 may be instantiated by any other combination of hardware, software, and/or firmware. For example, the loss calculation circuitry 110 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the uncertainty quantification calibration circuity 102 includes means for calculating the counts of samples of each classification type. For example, the means for calculating the counts of samples of each classification type may be implemented by sample classification and counting circuitry 112. In some examples, the sample classification and counting circuitry 112 may be instantiated by processor circuitry such as the example processor circuitry 312 of FIG. 3. For instance, the sample classification and counting circuitry 112 may be instantiated by the example microprocessor 400 of FIG. 4 executing machine executable instructions such as those implemented by at least block 202 of FIG. 2. In some examples, the sample classification and counting circuitry 112 may be instantiated by hardware logic circuitry, which may be implemented by an ASIC, XPU, or the FPGA circuitry 500 of FIG. 5 structured to perform operations corresponding to the machine readable instructions. Additionally or alternatively, the sample classification and counting circuitry 112 may be instantiated by any other combination of hardware, software, and/or firmware. For example, the sample classification and counting circuitry 112 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the uncertainty quantification calibration circuitry 102 includes means for calculating the uncertainty calibration loss (L_{EaUC}). For example, the means for calculating the uncertainty calibration loss (L_{EaUC}) may be implemented by L_{EaUC} calculation circuitry 114. In some examples, the L_{EaUC} calculation circuitry 114 may be instantiated by processor circuitry such as the example processor circuitry 312 of FIG. 3. For instance, the L_{EaUC} calculation circuitry 114 may be instantiated by the example microprocessor 400 of FIG. 4 executing machine executable instructions such as those implemented by at least block 204 of FIG. 2. In some examples, the L_{EaUC} calculation circuitry 114 may be instantiated by hardware logic circuitry, which may be implemented by an ASIC, XPU, or the FPGA circuitry 500 of FIG. 5 structured to perform operations corresponding to the machine readable instructions. Additionally or alternatively, the L_{EaUC} calculation circuitry 114 may be instantiated by any other combination of hardware, software, and/or firmware. For example, the L_{EaUC} calculation circuitry 114 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the uncertainty quantification calibration circuitry 102 includes means for calculating the final loss (L_{FINAL}) from the combined results of the standard negative log likelihood loss (L_{NLL}) and the L_{EaUC}. For example, the means for calculating the final loss (L_{FINAL}) from the combined results of the standard negative log likelihood loss (L_{NLL}) and the L_{EaUC} may be implemented by L_{FINAL} calculation circuitry 116. In some examples, the L_{FINAL} calculation circuitry 116 may be instantiated by processor circuitry such as the example processor circuitry 312 of FIG. 3. For instance, the L_{FINAL} calculation circuitry 116 may be instantiated by the example microprocessor 400 of FIG. 4 executing machine executable instructions such as those implemented by at least block 206 of FIG. 2. In some examples, the L_{FINAL} calculation circuitry 114 may be instantiated by hardware logic circuitry, which may be implemented by an ASIC, XPU, or the FPGA circuitry 500 of FIG. 5 structured to perform operations corresponding to the machine readable instructions. Additionally or alternatively, the L_{FINAL} calculation circuitry 116 may be instantiated by any other combination of hardware, software, and/or firmware. For example, the L_{FINAL} calculation circuitry 116 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the uncertainty quantification calibration circuitry 102 includes means for calibrating the regression (prediction) model circuitry 104 using the L_{FINAL} calculation function results to calibrate the regression model 104 (e.g., during training of the model) for an increased robustness of predictions. For example, the means for calibrating the regression (prediction) model circuitry 104 using the L_{FINAL} calculation function results to calibrate the regression model 104 (e.g., during training of the model) for an increased robustness of predictions may be implemented by optimization circuitry 118. In some examples, the optimization circuitry 118 may be instantiated by processor circuitry such as the example processor circuitry 312 of FIG. 3. For instance, the optimization circuitry 118 may be instantiated by the example microprocessor 400 of FIG. 4 executing machine executable instructions such as those implemented by at least block 208 of FIG. 2. In some examples, the optimization circuitry 118 may be instantiated by hardware logic circuitry, which may be implemented by an ASIC, XPU, or the FPGA circuitry 500 of FIG. 5 structured to perform operations corresponding to the machine readable instructions. Additionally or alternatively, the optimization circuitry 118 may be instantiated by any other combination of hardware, software, and/or firmware. For example, the optimization circuitry 118 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

While an example manner of implementing the uncertainty quantification calibration circuitry 102 is illustrated in FIG. 1, one or more of the elements, processes, and/or devices illustrated in FIG. 1 may be combined, divided, re-arranged, omitted, eliminated, and/or implemented in any other way. Further, the example regression model circuitry 104, the example neural network architecture circuitry 108, the example loss calculation circuitry 110, the example sample classification counting and calculation circuitry 112, the example L_{EaUC} calculation circuitry 114, the example L_{FINAL} circuitry 116, the example optimization circuitry 118, and/or, more generally, the example uncertainty quantification calibration circuitry 102 of FIG. 1, may be implemented by hardware, software, firmware, and/or any combination of hardware, software, and/or firmware. Thus, for example, any of the example the example regression model circuitry 104, the example neural network architecture circuitry 108, the example loss calculation circuitry 110, the example sample classification counting and calculation circuitry 112, the example L_{EaUC} calculation circuitry 114, the example L_{FINAL} circuitry 116, the example optimization circuitry 118, and/or, more generally, the example uncertainty quantification calibration circuitry 102, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). When reading any of the apparatus or system claims of this patent to cover a purely software and/or firmware implementation, at least one of the example uncertainty quantification calibration circuitry 102, the example regression model circuitry 104, the example neural network architecture circuitry 108, the example loss calculation circuitry 110, the example sample classification counting and calculation circuitry 112, the example L_{EaUC} calculation circuitry 114, the example L_{FINAL} circuitry 116, the example optimization circuitry 118 is/are hereby expressly defined to include a non-transitory computer readable storage device or storage disk such as a memory, a digital versatile disk (DVD), a compact disk (CD), a Blu-ray disk, etc., including the software and/or firmware. Further still, the example uncertainty quantification calibration circuitry 102 of FIG. 1 may include one or more elements, processes, and/or devices in addition to, or instead of, those illustrated in FIG. 1, and/or may include more than one of any or all of the illustrated elements, processes and devices.

A flowchart representative of example hardware logic circuitry, machine readable instructions, hardware implemented state machines, and/or any combination thereof for implementing the uncertainty quantification calibration circuitry 102 of FIG. 1 is shown in FIG. 2. The machine readable instructions may be one or more executable programs or portion(s) of an executable program for execution by processor circuitry, such as the processor circuitry 312 shown in the example processor platform 300 discussed below in connection with FIG. 3 and/or the example processor circuitry discussed below in connection with FIGS. 4 and/or 5. The program may be embodied in software stored on one or more non-transitory computer readable storage media such as a CD, a floppy disk, a hard disk drive (HDD), a DVD, a Blu-ray disk, a volatile memory (e.g., Random Access Memory (RAM) of any type, etc.), or a non-volatile memory (e.g., FLASH memory, an HDD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN) gateway that may facilitate communication between a server and an endpoint client hardware device). Similarly, the non-transitory computer readable storage media may include one or more mediums located in one or more hardware devices. Further, although the example program is described with reference to the flowchart illustrated in FIG. 2, many other methods of implementing the example uncertainty quantification calibration circuitry 102 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU), etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc., in order to execute the machine readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIG. 2 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium and non-transitory computer readable storage medium is expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 2 is a flowchart representative of example machine readable instructions and/or example operations 400 that may be executed and/or instantiated by processor circuitry to calibrate error aligned uncertainty for regression and continuous structured prediction tasks/optimizations.

The machine readable instructions and/or operations 200 of FIG. 2 begin at block 202, at which the example sample classification counting and calculation circuitry 112 calculates the count of samples corresponding to each accuracy-certainty classification category. In some examples, there are four accuracy-certainty classification categories (LC, LU, HU, and HC). In other examples, there are more or less than four accuracy-certainty classification categories based on the granularity of classifications utilized for fine tuning. In some examples, the sample classification counting and calculation circuitry 112 uses the count of samples calculation functions illustrated in Equation 5. In other examples, the sample classification counting and calculation circuitry 112 uses the count of samples calculation functions illustrated in Equation 3.

At block 204, the example L_{EaUC} calculation circuitry 116 calculates the trainable uncertainty calibration loss (L_{EaUC}) with the calculated counts of samples of each of the accuracy-certainty classification categories. In some examples, the L_{EaUC} calculation circuitry 116 uses the L_{EaUC} calculation function illustrated in Equation 4. In other examples, the L_{EaUC} calculation circuitry 116 uses the L_{EaUC} calculation function illustrated in Equation 2.

At block 206, the example L_{FINAL} calculation circuitry 118 calculates the final differentiable loss value. In some examples, the L_{FINAL} calculation circuitry 118 uses the L_{FINAL} calculation function illustrated in Equation 6. In other examples, the L_{FINAL} calculation circuitry 118 uses the L_{EaUC} calculation function illustrated in Equation 7.

At block 208, the optimization circuitry 120 calibrates the prediction model (e.g., regression model) using the calculated the final differentiable loss value. At this point the process concludes.

FIG. 3 is a block diagram of an example processor platform 300 structured to execute and/or instantiate the machine readable instructions and/or operations of FIG. 2 to implement the uncertainty quantification calibration circuitry 102 of FIG. 1. The processor platform 300 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing device.

The processor platform 300 of the illustrated example includes processor circuitry 312. The processor circuitry 312 of the illustrated example is hardware. For example, the processor circuitry 312 can be implemented by one or more integrated circuits, logic circuits, FPGAs microprocessors, CPUs, GPUs, DSPs, and/or microcontrollers from any desired family or manufacturer. The processor circuitry 312 may be implemented by one or more semiconductor based (e.g., silicon based) devices. In this example, the processor circuitry 312 implements the example uncertainty quantification calibration circuitry 102, the example regression model circuitry 104, the example neural network architecture circuitry 108, the example loss calculation circuitry 110, the example sample classification counting and calculation circuitry 112, the example L_{EaUC} calculation circuitry 114, the example L_{FINAL} circuitry 116, and the example optimization circuitry 118.

The processor circuitry 312 of the illustrated example includes a local memory 313 (e.g., a cache, registers, etc.). The processor circuitry 312 of the illustrated example is in communication with a main memory including a volatile memory 314 and a non-volatile memory 316 by a bus 318. The volatile memory 314 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 316 may be implemented by flash memory and/or any other desired type of memory device. Access to the main memory 314, 316 of the illustrated example is controlled by a memory controller 317.

The processor platform 300 of the illustrated example also includes interface circuitry 320. The interface circuitry 320 may be implemented by hardware in accordance with any type of interface standard, such as an Ethernet interface, a universal serial bus (USB) interface, a Bluetooth® interface, a near field communication (NFC) interface, a PCI interface, and/or a PCIe interface.

In the illustrated example, one or more input devices 322 are connected to the interface circuitry 320. The input device(s) 322 permit(s) a user to enter data and/or commands into the processor circuitry 312. The input device(s) 322 can be implemented by, for example, an audio sensor, a microphone, a camera (still or video), a keyboard, a button, a mouse, a touchscreen, a track-pad, a trackball, an isopoint device, and/or a voice recognition system.

One or more output devices 324 are also connected to the interface circuitry 320 of the illustrated example. The output devices 324 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 320 of the illustrated example, thus, typically includes a graphics driver card, a graphics driver chip, and/or graphics processor circuitry such as a GPU.

The interface circuitry 320 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 326. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 300 of the illustrated example also includes one or more mass storage devices 328 to store software and/or data. Examples of such mass storage devices 328 include magnetic storage devices, optical storage devices, floppy disk drives, HDDs, CDs, Blu-ray disk drives, redundant array of independent disks (RAID) systems, solid state storage devices such as flash memory devices, and DVD drives.

The machine executable instructions 332, which may be implemented by the machine readable instructions of FIG. 2, may be stored in the mass storage device 328, in the volatile memory 314, in the non-volatile memory 316, and/or on a removable non-transitory computer readable storage medium such as a CD or DVD.

FIG. 4 is a block diagram of an example implementation of the processor circuitry 312 of FIG. 3. In this example, the processor circuitry 312 of FIG. 3 is implemented by a microprocessor 400. For example, the microprocessor 400 may implement multi-core hardware circuitry such as a CPU, a DSP, a GPU, an XPU, etc. Although it may include any number of example cores 402 (e.g., 1 core), the microprocessor 400 of this example is a multi-core semiconductor device including N cores. The cores 402 of the microprocessor 400 may operate independently or may cooperate to execute machine readable instructions. For example, machine code corresponding to a firmware program, an embedded software program, or a software program may be executed by one of the cores 402 or may be executed by multiple ones of the cores 402 at the same or different times. In some examples, the machine code corresponding to the firmware program, the embedded software program, or the software program is split into threads and executed in parallel by two or more of the cores 402. The software program may correspond to a portion or all of the machine readable instructions and/or operations represented by the flowchart of FIG. 2.

The cores 402 may communicate by an example bus 404. In some examples, the bus 404 may implement a communication bus to effectuate communication associated with one(s) of the cores 402. For example, the bus 404 may implement at least one of an Inter-Integrated Circuit (I2C) bus, a Serial Peripheral Interface (SPI) bus, a PCI bus, or a PCIe bus. Additionally or alternatively, the bus 404 may implement any other type of computing or electrical bus. The cores 402 may obtain data, instructions, and/or signals from one or more external devices by example interface circuitry 406. The cores 402 may output data, instructions, and/or signals to the one or more external devices by the interface circuitry 406. Although the cores 402 of this example include example local memory 420 (e.g., Level 1 (L1) cache that may be split into an L1 data cache and an L1 instruction cache), the microprocessor 400 also includes example shared memory 410 that may be shared by the cores (e.g., Level 2 (L2_cache)) for high-speed access to data and/or instructions. Data and/or instructions may be transferred (e.g., shared) by writing to and/or reading from the shared memory 410. The local memory 420 of each of the cores 402 and the shared memory 410 may be part of a hierarchy of storage devices including multiple levels of cache memory and the main memory (e.g., the main memory 314, 316 of FIG. 3). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 402 may be referred to as a CPU, DSP, GPU, etc., or any other type of hardware circuitry. Each core 402 includes control unit circuitry 414, arithmetic and logic (AL) circuitry (sometimes referred to as an ALU) 416, a plurality of registers 418, the L1 cache 420, and an example bus 422. Other structures may be present. For example, each core 402 may include vector unit circuitry, single instruction multiple data (SIMD) unit circuitry, load/store unit (LSU) circuitry, branch/jump unit circuitry, floating-point unit (FPU) circuitry, etc. The control unit circuitry 414 includes semiconductor-based circuits structured to control (e.g., coordinate) data movement within the corresponding core 402. The AL circuitry 416 includes semiconductor-based circuits structured to perform one or more mathematic and/or logic operations on the data within the corresponding core 402. The AL circuitry 416 of some examples performs integer based operations. In other examples, the AL circuitry 416 also performs floating point operations. In yet other examples, the AL circuitry 416 may include first AL circuitry that performs integer based operations and second AL circuitry that performs floating point operations. In some examples, the AL circuitry 416 may be referred to as an Arithmetic Logic Unit (ALU). The registers 418 are semiconductor-based structures to store data and/or instructions such as results of one or more of the operations performed by the AL circuitry 416 of the corresponding core 402. For example, the registers 418 may include vector register(s), SIMD register(s), general purpose register(s), flag register(s), segment register(s), machine specific register(s), instruction pointer register(s), control register(s), debug register(s), memory management register(s), machine check register(s), etc. The registers 418 may be arranged in a bank as shown in FIG. 4. Alternatively, the registers 418 may be organized in any other arrangement, format, or structure including distributed throughout the core 402 to shorten access time. The bus 420 may implement at least one of an I2C bus, a SPI bus, a PCI bus, or a PCIe bus.

Each core 402 and/or, more generally, the microprocessor 400 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 400 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

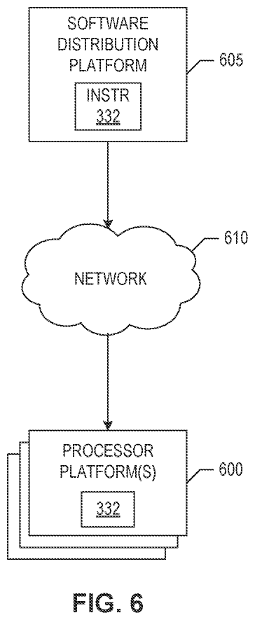

FIG. 6 is a block diagram of another example implementation of the processor circuitry 312 of FIG. 3. In this example, the processor circuitry 312 is implemented by FPGA circuitry 500. The FPGA circuitry 500 can be used, for example, to perform operations that could otherwise be performed by the example microprocessor 400 of FIG. 4 executing corresponding machine readable instructions. However, once configured, the FPGA circuitry 500 instantiates the machine readable instructions in hardware and, thus, can often execute the operations faster than they could be performed by a general purpose microprocessor executing the corresponding software.

More specifically, in contrast to the microprocessor 400 of FIG. 4 described above (which is a general purpose device that may be programmed to execute some or all of the machine readable instructions represented by the flowchart of FIG. 2 but whose interconnections and logic circuitry are fixed once fabricated), the FPGA circuitry 500 of the example of FIG. 5 includes interconnections and logic circuitry that may be configured and/or interconnected in different ways after fabrication to instantiate, for example, some or all of the machine readable instructions represented by the flowchart of FIG. 2. In particular, the FPGA 500 may be thought of as an array of logic gates, interconnections, and switches. The switches can be programmed to change how the logic gates are interconnected by the interconnections, effectively forming one or more dedicated logic circuits (unless and until the FPGA circuitry 500 is reprogrammed). The configured logic circuits enable the logic gates to cooperate in different ways to perform different operations on data received by input circuitry. Those operations may correspond to some or all of the software represented by the flowchart of FIG. 2. As such, the FPGA circuitry 500 may be structured to effectively instantiate some or all of the machine readable instructions of the flowchart of FIG. 2 as dedicated logic circuits to perform the operations corresponding to those software instructions in a dedicated manner analogous to an ASIC. Therefore, the FPGA circuitry 500 may perform the operations corresponding to the some or all of the machine readable instructions of FIG. 2 faster than the general purpose microprocessor can execute the same.

In the example of FIG. 5, the FPGA circuitry 500 is structured to be programmed (and/or reprogrammed one or more times) by an end user by a hardware description language (HDL) such as Verilog. The FPGA circuitry 500 of FIG. 5, includes example input/output (I/O) circuitry 502 to obtain and/or output data to/from example configuration circuitry 504 and/or external hardware (e.g., external hardware circuitry) 506. For example, the configuration circuitry 504 may implement interface circuitry that may obtain machine readable instructions to configure the FPGA circuitry 500, or portion(s) thereof. In some such examples, the configuration circuitry 504 may obtain the machine readable instructions from a user, a machine (e.g., hardware circuitry (e.g., programmed or dedicated circuitry) that may implement an Artificial Intelligence/Machine Learning (AI/ML) model to generate the instructions), etc. In some examples, the external hardware 506 may implement the microprocessor 400 of FIG. 4. The FPGA circuitry 500 also includes an array of example logic gate circuitry 508, a plurality of example configurable interconnections 510, and example storage circuitry 512. The logic gate circuitry 508 and interconnections 510 are configurable to instantiate one or more operations that may correspond to at least some of the machine readable instructions of FIG. 2 and/or other desired operations. The logic gate circuitry508 shown in FIG. 5 is fabricated in groups or blocks. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 508 to enable configuration of the electrical structures and/or the logic gates to form circuits to perform desired operations. The logic gate circuitry 508 may include other electrical structures such as look-up tables (LUTs), registers (e.g., flip-flops or latches), multiplexers, etc.

The interconnections 510 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 508 to program desired logic circuits.

The storage circuitry 512 of the illustrated example is structured to store result(s) of the one or more of the operations performed by corresponding logic gates. The storage circuitry 512 may be implemented by registers or the like. In the illustrated example, the storage circuitry 512 is distributed amongst the logic gate circuitry 508 to facilitate access and increase execution speed.

The example FPGA circuitry 500 of FIG. 5 also includes example Dedicated Operations Circuitry 514. In this example, the Dedicated Operations Circuitry 514 includes special purpose circuitry 516 that may be invoked to implement commonly used functions to avoid the need to program those functions in the field. Examples of such special purpose circuitry 516 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 500 may also include example general purpose programmable circuitry 518 such as an example CPU 520 and/or an example DSP 522. Other general purpose programmable circuitry 518 may additionally or alternatively be present such as a GPU, an XPU, etc., that can be programmed to perform other operations.

Although FIGS. 4 and 5 illustrate two example implementations of the processor circuitry 312 of FIG. 3, many other approaches are contemplated. For example, as mentioned above, modern FPGA circuitry may include an on-board CPU, such as one or more of the example CPU 520 of FIG. 5. Therefore, the processor circuitry 312 of FIG. 3 may additionally be implemented by combining the example microprocessor 400 of FIG. 4 and the example FPGA circuitry 500 of FIG. 5. In some such hybrid examples, a first portion of the machine readable instructions represented by the flowchart of FIG. 2 may be executed by one or more of the cores 402 of FIG. 4 and a second portion of the machine readable instructions represented by the flowchart of FIG. 2 may be executed by the FPGA circuitry 500 of FIG. 5.

In some examples, the processor circuitry 312 of FIG. 3 may be in one or more packages. For example, the processor circuitry 400 of FIG. 4 and/or the FPGA circuitry 500 of FIG. 5 may be in one or more packages. In some examples, an XPU may be implemented by the processor circuitry 312 of FIG. 3, which may be in one or more packages. For example, the XPU may include a CPU in one package, a DSP in another package, a GPU in yet another package, and an FPGA in still yet another package.

A block diagram illustrating an example software distribution platform 605 to distribute software such as the example machine readable instructions 332 of FIG. 3 to hardware devices owned and/or operated by third parties is illustrated in FIG. 6. The example software distribution platform 605 may be implemented by any computer server, data facility, cloud service, etc., capable of storing and transmitting software to other computing devices. The third parties may be customers of the entity owning and/or operating the software distribution platform 605. For example, the entity that owns and/or operates the software distribution platform 605 may be a developer, a seller, and/or a licensor of software such as the example machine readable instructions 332 of FIG. 3. The third parties may be consumers, users, retailers, OEMs, etc., who purchase and/or license the software for use and/or re-sale and/or sub-licensing. In the illustrated example, the software distribution platform 605 includes one or more servers and one or more storage devices. The storage devices store the machine readable instructions 332, which may correspond to the example machine readable instructions 200 of FIG. 2, as described above. The one or more servers of the example software distribution platform 605 are in communication with a network 610, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 332 from the software distribution platform 605. For example, the software, which may correspond to the example machine readable instructions 200 of FIG. 2, may be downloaded to the example processor platform 400, which is to execute the machine readable instructions 332 to implement the uncertainty quantification calibration circuitry 102. In some example, one or more servers of the software distribution platform 605 periodically offer, transmit, and/or force updates to the software (e.g., the example machine readable instructions 332 of FIG. 3) to ensure improvements, patches, updates, etc., are distributed and applied to the software at the end user devices.

The performance of the apparatus and method to calibrate error aligned uncertainty for regression and continuous structured prediction tasks/optimizations is discussed below. The performance of both the continuous structured prediction and the regression tasks were evaluated using publicly available data sets.

The Error aligned Uncertainty Calibration (EaUC) loss benefits regression models by improving the quality of predictive uncertainty. The calibration method described was adapted to a more challenging continuous structured prediction task, vehicle motion prediction. The real-world Shifts vehicle motion prediction dataset and benchmark was utilized because it is a real-world task and representative of an actual industrial application as collected by Yandex Self Driving Group. In this task, distributional shift is ubiquitous, and it is affected by real, ‘in-the-wild’ distributional shifts which pose challenges for uncertainty estimation.

Shifts Dataset has data collected from six geographical locations, three seasons, three times of day, and four weather conditions to evaluate the quality of uncertainty under distributional shift. Currently it is the largest vehicle motion prediction dataset, containing 600,000 scenes. It consists of both in-distribution and shifted datasets.

In Shifts benchmark, optimization is done based on NLL objective, and results are reported for two baseline architectures, which are the stochastic Behavioral Cloning (BC) Model and the Deep Imitative Model (DIM). The results are reported incorporating the ‘Error Aligned Uncertainty Calibration’ loss L_{EaUC} as secondary loss to Shifts pipeline as shown in Equation 6.

The aim is to learn distributions capturing uncertainty during training to better estimate uncertainty during inference through sampling and to predict trajectories for the next 5 seconds with data collected with 5 Hz sampling rate, which makes the length of the prediction 25.

During training, for each BC and DIM models, the density estimator (likelihood model) is generated by teacher-forcing (e.g., from the distribution of ground truth trajectories). The model is trained with AdamW optimizer with a learning rate (LR) of 1e-4, using a cosine annealing LR schedule with 1 epoch warmup, and gradient clipping at 1. Training is stopped after 100 epochs in each experiment.

During inference, Robust Imitative Planning is applied. Sampling is applied on the likelihood model considering a predetermined number of predictions G=10. Top D=5 predictions of the model (or multiple models in the use of ensembles) is selected according to their log likelihood. The predictive performance of the model using the weightedADE metric is shown. The quality of the relative weighting of the D trajectories with their corresponding normalized per-trajectory confidence scores C^{˜d}, computed by applying softmax to log likelihood scores for each prediction, is assessed by calculating the weightedADE metric:

$$Weighted A D E metric calculation function . \qquad Equation 8$$

$$weighted A D {E}_{D} ( q ) := {\sum }_{d ∈ D} {c}^{\sim ( d )} \cdot A D E ( {y}^{( d )} ) .$$

The joint quality assessment of uncertainty and robustness is achieved using both error retention curves and FI-weightedADE retention curves. The error metric is weightedADE and the retention fraction is based on per-prediction uncertainty score U in the retention curves. Mean Averaging is applied while computing U based on the per-plan log-likelihoods as well as for the aggregation of ensemble results.

The secondary loss incentivizes the model to align the uncertainty with average displacement error (ADE) while training the model. Experimental results are conducted by setting β (see Equation 7) as 200, adeₜₕ and uₜₕ as 0.8 and 0.6, respectively, for both BC and DIM models.

tanh is applied as bounding function for the robustness measure ade after scaling it with weight x (see Equation 5) to make the values applicable for the bounding function. x is set to 0.5 (x=0.5) so that samples are assigned with ADE below 1.6 as an accurate sample. In F1-retention evaluations, acceptable prediction threshold is selected as 1.6 as well.

The uncertainty metric is the confidence value based on log likelihood. To get a meaningful representation of uncertainty in the loss, likelihood scores were clipped between 0 and 100 range (numbers <0 set to eps and numbers >100 set to 100). Then confidence is normalized to [0, 1] range, and the output is directly used as the uncertainty measure (c, in Equation 5).

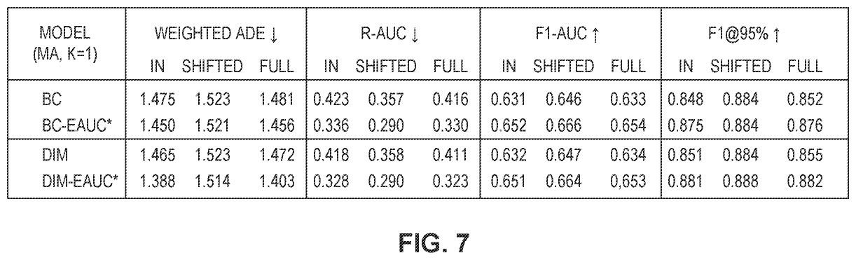

FIG. 7 illustrates the results for the joint quality assessment of uncertainty and robustness using R-AUC, F1-AUC, F1@95% metrics. Predictive performance is computed with the weightedADE metric, which is also the error metric of retention plots. Here, the F1@95% metric is a single point summary jointly of the uncertainty and robustness. 95% retention is selected as a particular operating point, and the error evaluated at that point is used for comparison.

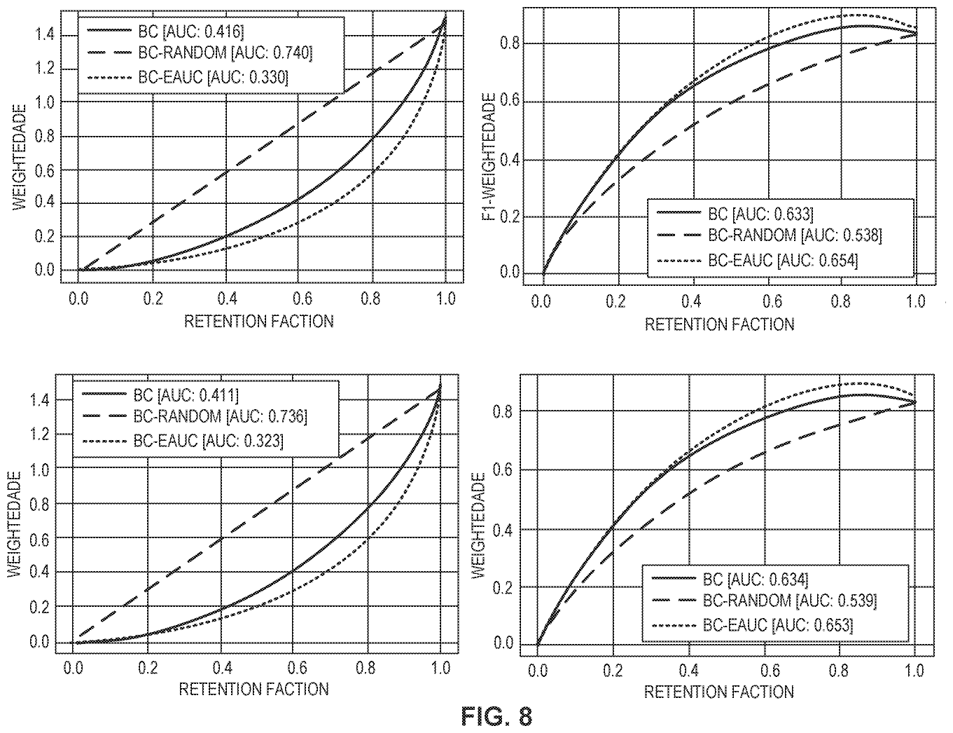

FIG. 8 illustrates error retention plot (left) and F1-weightedADE retention plot (right) for both BC and DIM baselines with/without the calibration loss. The results in FIGS. 7 and 8 show that:

R-AUC decreases, and F1-AUC and F1@95% increase for both models using all Full, In, and Shifted datasets with the L_{EaUC} loss, which indicates better calibration performance using all three metrics. The example apparatus and method disclosed herein to calibrate error aligned uncertainty for regression and continuous structured prediction tasks/optimizations outperform the results on two baselines, which indicates the approach disclosed herein provides well-calibrated uncertainties.

In addition to improving the quality of uncertainty, the approach to calculate calibration loss herein improves the model performance by reducing the weightedADE by 1.69% and 4.69% for BC and DIM, respectively.

weightedADE is observed to be higher for Shifted dataset compared to In-distribution dataset, which indicates that error is higher for out-of-distribution data.

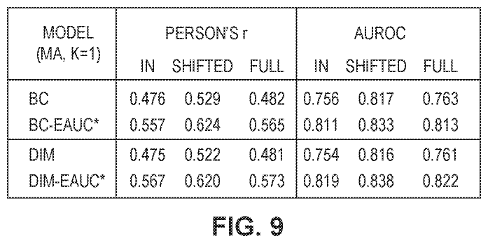

Setting the accurate prediction threshold as 1.6, for the binary classification of samples as accurate and inaccurate, AUROC increases from 0.763 to 0.813, and from 0.761 to 0.822 when L_{EaUC} is incorporated to BC and DIM models, respectively (see FIG. 9).

FIG. 9 illustrates an evaluation of Pearson's correlation coefficient where X and Y had observed improvement in correlation of error and uncertainty incorporating L_{EaUC} loss to BC and DIM models, respectively.

Impact of Assigning Higher Weights to the Class of Accurate and Certain Samples (LC) in the EaUC Loss:

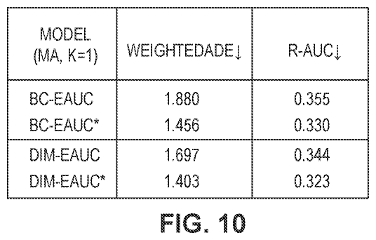

In safety-critical model prediction scenarios, it is important to have certainty in predictions when the predictions are accurate. FIG. 10 illustrates the results of uncertainty predictions as a result of assigning higher weights to the LC classification. By assigning the higher LC weight, the algorithm is forced to learn the samples of this class better and, as a result, improved calibration (well-calibrated) and robustness (lower weightedADE) are obtained when assigning higher weights to the class of accurate and certain samples (LC).

BC-EaUC/DIM-EaUC and BC-EaUC*/DIM-EaUC* denote the results according to Equation 5 and according to Equation 7, respectively. BC-EaUC* and DIM-EaUC* provide better performance in terms of robustness (weightedADE) and model calibration (R-AUC) compared to BC-EaUC and DIM-EaUC. Thus, experiments reported in FIG. 10 are reported applying the loss according to Equation 7 setting s=3 for both models. FIG. 10 shows the results on Full dataset.

Additionally, even though BC-EaUC and DIM-EaUC provide not improved robustness (weightedADE) compared to their corresponding baseline performances (BC and DIM in FIG. 7), they still provide better performances in terms of model calibration using the joint assessment metric R-AUC. As R-AUC improves either due to improved model performance (i.e., weightedADE) or improving the quality of uncertainty estimates, the reason of the improvement here is dependent on the improved quality of uncertainty estimates with the L_{EaUC} loss.

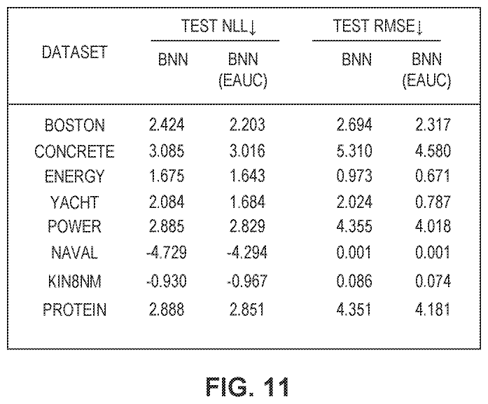

The disclosed method herein was evaluated on UCI regression datasets. The Bayesian neural network (BNN) is used with Monte Carlo dropout approximate Bayesian inference. In this setup, the neural network is used with two hidden layers fully-connected with 100 neurons and a ReLU activation. A dropout layer with probability of 0.5 is used after each hidden layer, with 20 Monte Carlo samples for approximate Bayesian inference. The optimal hyperparameters for each dataset using Bayesian optimization with HyperBand and the models are trained with an SGD optimizer and batch size of 128. The predictive variance from Monte Carlo forward passes is used as the uncertainty measure within the error aligned uncertainty calibration (EaUC) loss. FIG. 11 illustrates a BNN trained with a secondary EaUC loss yielding lower predictive negative log likelihood and lower RMSE on multiple UCI datasets.

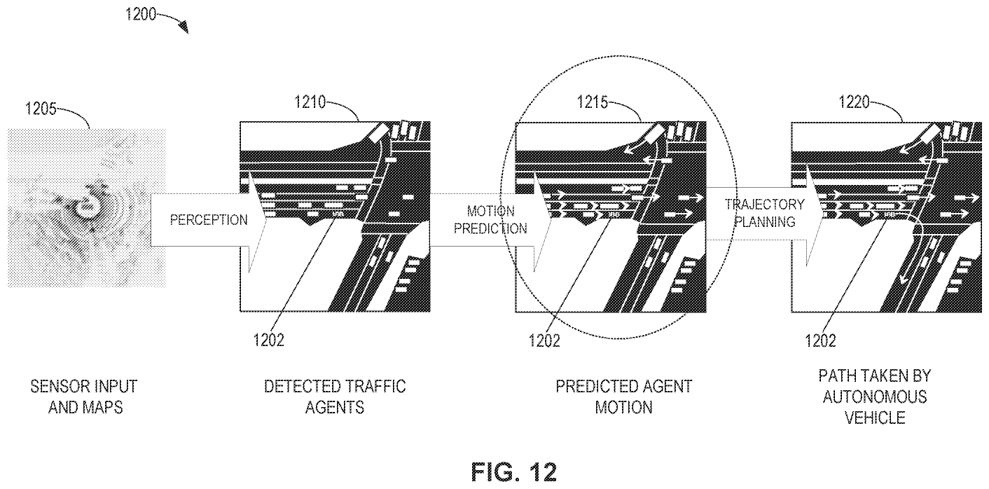

FIG. 12 illustrates a high-level overview of an autonomous driving pipeline, based on the teachings of this disclosure. The example first stage 1205 includes collection of data from various sensors (e.g., audio sensors, microphones, cameras (still or video), etc.) and/or maps by an automatic vehicle system (e.g., example system 100 of FIG. 1). The example second stage 1210 includes detection of nearby traffic agents by a target vehicle 1202 based on the data collected in the first stage 1205. Once nearby traffic agents have been detected, the third stage 1215 includes prediction of a trajectory of motion for each of the traffic agents detected in the example second stage 1210. In examples disclosed herein, an example system (e.g., example system 100) may be used to calibrate uncertainty of this trajectory prediction model, in accordance with the teachings of this disclosure (e.g., by the uncertainty quantification calibration circuitry 102, etc.). Lastly, at the example fourth stage 1220, the example target vehicle 1202 takes its path based on the predictions of the third stage 1215, relative to the anticipated trajectories of the nearby traffic agents.

From the foregoing, it will be appreciated that example systems, methods, apparatus, and articles of manufacture have been disclosed that calibrate error aligned uncertainty for regression and continuous structured prediction tasks/optimizations. The disclosed systems, methods, apparatus, and articles of manufacture improve the efficiency of using a computing device by improving the calibration of an uncertainty prediction model to make the model more robust. The disclosed systems, methods, apparatus, and articles of manufacture are accordingly directed to one or more improvement(s) in the operation of a machine such as a computer or other electronic and/or mechanical device.

Further examples and combinations thereof include the following:

Example 1 includes an apparatus, comprising a prediction model, at least one memory, instructions, and processor circuitry to at least one of execute or instantiate the instructions to calculate a count of samples corresponding to an accuracy-certainty classification category, calculate a trainable uncertainty calibration loss value based on the calculated count, calculate a final differentiable loss value based on the trainable uncertainty calibration loss value, and calibrate the prediction model with the final differentiable loss value.

Example 2 includes the apparatus of example 1, wherein the accuracy-certainty classification category contains one of accurate and certain samples, inaccurate and certain samples, accurate and uncertain samples, or inaccurate and uncertain samples.

Example 3 includes the apparatus of example 1, wherein the count of samples corresponding to the accuracy-certainty classification category is determined using a regression model.

Example 4 includes the apparatus of example 1, wherein a standard negative log likelihood loss is calculated as a primary loss value.

Example 5 includes the apparatus of example 4, wherein the standard negative log likelihood loss is added to the trainable uncertainty calibration loss to calculate the final differentiable loss value.

Example 6 includes the apparatus of example 1, wherein a robustness score is calculated and used to calibrate the prediction model with the final differentiable loss value.

Example 7 includes the apparatus of example 6, wherein the robustness score is calculated using an Average Displacement Error (ADE).

Example 8 includes a non-transitory computer readable medium comprising instructions that, when executed, cause a machine to at least calculate a count of samples corresponding to an accuracy-certainty classification category, calculate a trainable uncertainty calibration loss value based on the calculated count, calculate a final differentiable loss value based on the trainable uncertainty calibration loss value, and calibrate a prediction model with the final differentiable loss value.

Example 9 includes the non-transitory computer readable medium of example 8, wherein the accuracy-certainty classification category contains one of accurate and certain samples, inaccurate and certain samples, accurate and uncertain samples, or inaccurate and certain samples.

Example 10 includes the non-transitory computer readable medium of example 8, wherein the count of samples corresponding to the accuracy-certainty classification category is determined using a regression model.

Example 11 includes the non-transitory computer readable medium of example 8, wherein a standard negative log likelihood loss is calculated as a primary loss value.

Example 12 includes the non-transitory computer readable medium of example 11, wherein the standard negative log likelihood loss is added to the trainable uncertainty calibration loss to calculate the final differentiable loss value.

Example 13 includes the non-transitory computer readable medium of example 8, wherein a robustness score is calculated and used to calibrate the prediction model with the final differentiable loss value.

Example 14 includes the non-transitory compute readable medium of example 13, wherein the robustness score is calculated using an Average Displacement Error (ADE).

Example 15 includes a method for uncertainty calibration, the method comprising calculating a count of samples corresponding to an accuracy-certainty classification category, calculating a trainable uncertainty calibration loss value based on the calculated count, calculating a final differentiable loss value based on the trainable uncertainty calibration loss value, and calibrating a prediction model with the final differentiable loss value.

Example 16 includes the method of example 15, wherein the accuracy-certainty classification category contains one of accurate and certain samples, inaccurate and certain samples, accurate and uncertain samples, or inaccurate and uncertain samples.

Example 17 includes the method of example 15, wherein the count of samples corresponding to the accuracy-certainty classification category is determined using a regression model.

Example 18 includes the method of example 15, wherein a standard negative log likelihood loss is calculated as a primary loss value.

Example 19 includes the method of example 18, wherein the standard log likelihood loss is added to the trainable uncertainty calibration loss to calculate the final differentiable loss value.

Example 20 includes the method of example 15, wherein a robustness score is calculated and used to calibrate the prediction model with the final differentiable loss value.

Example 21 includes the method of example 20, wherein the robustness score is calculated using an Average Displacement Error (ADE).

Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

The following claims are hereby incorporated into this Detailed Description by this reference, with each claim standing on its own as a separate embodiment of the present disclosure.

What is claimed is:

1. An apparatus, comprising:
a prediction model;
at least one memory;
instructions; and
processor circuitry to at least one of execute or instantiate the instructions to:
calculate a count of samples corresponding to an accuracy-certainty classification category;
calculate a trainable uncertainty calibration loss value based on the calculated count;
calculate a final differentiable loss value based on the trainable uncertainty calibration loss value; and
calibrate the prediction model with the final differentiable loss value.

2. The apparatus of claim 1, wherein the accuracy-certainty classification category contains one of accurate and certain samples, inaccurate and certain samples, accurate and uncertain samples, or inaccurate and uncertain samples.

3. The apparatus of claim 1, wherein the count of samples corresponding to the accuracy-certainty classification category is determined using one or more of a regression or continuous structured prediction model.

4. The apparatus of claim 1, wherein a standard negative log likelihood loss is calculated as a primary loss value.

5. The apparatus of claim 4, wherein the standard negative log likelihood loss is added to the trainable uncertainty calibration loss to calculate the final differentiable loss value.

6. The apparatus of claim 1, wherein a robustness score is calculated and used to calibrate the prediction model with the final differentiable loss value.

7. The apparatus of claim 6, wherein the robustness score is calculated using an Average Displacement Error (ADE).

8. A non-transitory computer readable medium comprising instructions that, when executed, cause a machine to at least:
calculate a count of samples corresponding to an accuracy-certainty classification category;
calculate a trainable uncertainty calibration loss value based on the calculated count;
calculate a final differentiable loss value based on the trainable uncertainty calibration loss value; and
calibrate a prediction model with the final differentiable loss value.

9. The non-transitory computer readable medium of claim 8, wherein the accuracy-certainty classification category contains one of accurate and certain samples, inaccurate and certain samples, accurate and uncertain samples, or inaccurate and certain samples.

10. The non-transitory computer readable medium of claim 8, wherein the count of samples corresponding to the accuracy-certainty classification category is determined using one or more of a regression or continuous structured prediction model.

11. The non-transitory computer readable medium of claim 8, wherein a standard negative log likelihood loss is calculated as a primary loss value.

12. The non-transitory computer readable medium of claim 11, wherein the standard negative log likelihood loss is added to the trainable uncertainty calibration loss to calculate the final differentiable loss value.

13. The non-transitory computer readable medium of claim 8, wherein a robustness score is calculated and used to calibrate the prediction model with the final differentiable loss value.

14. The non-transitory compute readable medium of claim 13, wherein the robustness score is calculated using an Average Displacement Error (ADE).

15. A method for uncertainty calibration, the method comprising:
calculating a count of samples corresponding to an accuracy-certainty classification category;
calculating a trainable uncertainty calibration loss value based on the calculated count;
calculating a final differentiable loss value based on the trainable uncertainty calibration loss value; and
calibrating a prediction model with the final differentiable loss value.

16. The method of claim 15, wherein the accuracy-certainty classification category contains one of accurate and certain samples, inaccurate and certain samples, accurate and uncertain samples, or inaccurate and uncertain samples.

17. The method of claim 15, wherein the count of samples corresponding to the accuracy-certainty classification category is determined using one or more of a regression or continuous structured prediction model.

18. The method of claim 15, wherein a standard negative log likelihood loss is calculated as a primary loss value.

19. The method of claim 18, wherein the standard log likelihood loss is added to the trainable uncertainty calibration loss to calculate the final differentiable loss value.

20. The method of claim 15, wherein a robustness score is calculated and used to calibrate the prediction model with the final differentiable loss value.

21. The method of claim 20, wherein the robustness score is calculated using an Average Displacement Error (ADE).
